(19) United States
(12) Patent Application Publication
(10) Pub. No.: US 2011/0099157 A1
(43) Pub. Date: Apr. 28, 2011

(54) Computer-to-Computer Communications

(75) Inventors: Michael J. LeBeau, Palo Alto, CA (US); John Nicholas Jitkoff, Palo Alto, CA (US)

(73) Assignee: Google Inc.

(21) Appl. No.: 12/914,746

(22) Filed: Oct. 28, 2010

Related U.S. Application Data
(60) Provisional application No. 61/255,847, filed on Oct. 28, 2009.
(60) Provisional application No. 61/346,870, filed on May 20, 2010.

(51) Int. Cl. G06F 17/30; G10L 15/26; G10L 21/00

(52) U.S. Cl. 707/706; 704/235; 704/275; 707/722; 704/E15.043; 704/E21.001; 707/E17.108

(57) ABSTRACT

A computer-implemented method for information sharing between computers includes receiving at a computer system a search request from a first computer, generating with the computer system one or more search results that are responsive to the first computer, formatting the results for display on a second computer that is different than the first computer, and automatically providing the results for display on the second computer.

### CROSS-REFERENCE TO RELATED APPLICATION

This application claims priority to U.S. Provisional Application Ser. No. 61/255,847, filed on Oct. 28, 2009, entitled “Search, Navigation, and Docking with a Mobile Computing Device,” and U.S. Provisional Application Ser. No. 61/346,870, filed May 20, 2010, entitled “Computer-to-Computer Communication,” the entire contents of which are both hereby incorporated by reference.

### TECHNICAL FIELD

This document relates to submitting data, such as a search query, on a first computer, such as a smartphone, and having results from the submitted data, such as search results, appear automatically on a second computer, such as a television monitor or a desktop computer.

### BACKGROUND

People interact more and more with computers, and they also interact more and more with different kinds of computers. While desktop and laptop computers may have been the most prevalent computers in people's lives in the past, most people are more likely now to interact with smart phones, DVRs, televisions, and other consumer devices that include computers in them.

Certain computers are well-suited for entering and editing information, such as desktop and laptop computers. Other devices are better suited to delivering information but not receiving it, such as televisions that do not include keyboards or have keyboards of limited size. Also, some computers are best used in certain situations, and other computers in other situations. For example, a smartphone is typically best used on-the-go and at close quarters. In contrast, a television is better used while a user is stationary, and frequently from relatively long-distances.

### SUMMARY

This document discusses systems and techniques by which a person may enter data using one computer, and may use associated data by employing another computer. The associated data may be generated at the other computer based on the user's submission at the first computer. The linking of the two computers may occur by recognizing that the user has logged into a common user account at a central server system from the two different computers. For example, a user may speak a voice query into his or her smart phone and may have visual search results, such as a numbered list of web search results, displayed on a different computer, such as a touchscreen tablet display device or a television display. In another situation, a user may speak a query into their smartphone device, and have search results displayed on a desktop computer.

The display may be delayed, such as if the second computer is not currently logged onto the system, and so that the results may be delivered when the user subsequently logs on. The results for such a delayed delivery may be generated at the time the request is submitted (and may be stored) or at the time the user later gets them at the second computer (so that the request is stored and is then executed when delivery of the results is to occur). For example, the user may seek some information while driving in their car, but not be able to interact with it at the present time (because they are busy and/or because the results are not the type of thing that can be interacted with effectively on a smartphone). The results in such a situation could, therefore, be sent automatically for display on the user's desktop computer. When such a user gets to work and is no longer driving, he or she may boot up his or her desktop computer, and may readily access the search results that were previously requested. For example, a pop-up alert may be displayed on the user's computer, and may include selectable links or other objects that show all such waiting results that the user may then review. The generation of search results in such a situation may occur at the time that the request is made, at the time the user logs in to the target computer, or in other situations. Also, a composite of results from both time periods may be presented to the user.

The data that results from these initial submissions by the user at the source computer may be provided to the target computer in a variety of ways. For example, each of the computers may be registered and logged in with the online service to which the request is made, so that the service may readily route the results to the target computer, such as when the target computer logs into the same user account as the source computer was logged into when its relevant operations occurred. An object may thus be stored at a server system when a user performs actions on the first computer, and the object may be held until the user logs into the account from another computer. In some situations, the target computer may be identified explicitly or implicitly by the user, such as where the user performs an action that can only be completed on a particular other type of computer. For example, a user may perform an action while watching an internet-enabled TV that causes results that can only be reviewed on a full desktop computer—if the user later logs into his account from a smartphone, the object will not be activated, but will instead be held by the hosted system until the user logs in from a desktop computer.

Alternatively, or in addition, a search service may provide the results back to the source computer which may then relate the results to the target computer, such as over a short range wireless networking blank. Thus, instead of having the results cross across the internet between devices, that can instead be returned to the source device, which may then provide them directly (e.g., without going through a network) to a target computer. Also, a central system may format the results differently depending on the type of computer to which it is sending the results. For example, when a user registers his or her devices with a central system, the user may provide device indicators (e.g., make and model information) so that the system can determine the display capabilities of each of the user's computers, and can then provide appropriate results to the particular computer that matches the needed capabilities for the results.

The techniques discussed here may, in certain implementations, provide one or more advantages. For example, a user of multiple computing devices may be allowed to submit information using a computing device that is best-suited to such submission, and may review the information (or resulting information), on a different computing device that is better-suited for such review. Such techniques may also allow a user of multiple computers to easily extend the functionality of computers that they already own. For example, software to enable such data submission and routing may be easily added to a smartphone, or a user may simply use a browser on the smartphone to log into an account on a hosted service that may then pass the information to a browser on another device, or the provider of the account may recognize that certain search results should be provided to a target computer that has previously been registered with, or logged into, the account.

In one implementation, a computer-implemented method for information sharing comprises receiving a search request from a first computer, and generating one or more search results that are responsive to the first computer. The method also comprises formatting the results for display on a second computer that is different than the first computer, and providing the results for display on the second computer. The method can also include identifying the second computer by identifying a user account to which the first computer corresponds and identifying additional computers that correspond to the user account. Also, providing the results for display on the second computer can comprise providing the results to the first computer for forwarding to the second computer. The method can also include receiving a request type for the search request, and automatically selecting the second computer based on the request type. The method also can include providing the results for display on the second computer only if the request type is a predetermined request type.

In certain aspects, the request type is a television request type, and the second computer comprises a television. Also, the method can include determining that the second computer is not currently available to display the results, and storing the results at a central server system until the second computer is available to display the results. The method can also include receiving from the second computer an indication that a user has selected a portion of the results, and providing the selected portion of the results to the first computer through a central server system over the internet in response to receiving the indication. The search request can be received as a sound file, and further comprising converting the search request from speech to text.

In another implementation, a computer-implemented system for information sharing is disclosed. The system comprises a server interface arranged to receive search queries from a user of a remote source computer; a search engine to generate results responsive to the received search queries; and a search result router arranged to cause the results to be automatically provided to a remote target computer that is associated with the user and is different from the remote source computer. The server interface can be programmed to convert speech queries to text. Also, the search result router can be arranged to identify an address of the remote source computer by identifying computer that are associated with an account with which the source computer is associated.

In yet another implementation, a method for controlling a first computing device is disclosed that comprises receiving an instruction from a user at a second computing device; transmitting information about the instruction to the first computing device; and executing the instruction at the first computing device upon the user checking in at the first computing device. The instruction can be received as a voice command at the second computing device and translated into a computer-executable instruction for the first computing device. Also, the instruction can include an action and a target for the action. The target for the action can also comprise a software application that is executable on the first computing device, and the action comprises one or more steps to be automatically executed by the application.

The details of one or more embodiments are set forth in the accompanying drawings and the description below. Other features and advantages will be apparent from the description and drawings, and from the claims.

### DESCRIPTION OF DRAWINGS

FIGS. 1A and 1B show two examples by which data may be submitted a first computer and reviewed and handle that a second computer.

FIG. 2A is a schematic diagram of a system for sharing information between computers.

FIG. 2B is a block diagram of a mobile computing device and system for sharing information between computers.

FIG. 3 is a flow chart that shows a process for receiving a request from a first computer in supplying information that is responsive to the request to a second computer.

FIGS. 4A and 4B are swim lane diagrams for coordinating information submission and information provision between various computers and a central server system.

FIG. 5 is a block diagram of computing devices 500, 550 that may be used to implement the systems and methods described in this document, as either a client or as a server or plurality of servers.

### DETAILED DESCRIPTION

This document describes systems and related techniques for passing information from a first computer to a server system, creating information that is responsive to the passed information using the server system, and then automatically routing responsive information from the server system to a second computer that is different than the first computer. In one example, a search query is submitted to a search engine from a first computer, and search results responsive to the query are automatically routed to another device that is associated with the user who submitted the query (as determined by the user account to which the device that submitted the query was logged in). The user may then interact with the results at the other device and may pass the results of such interaction back to the first device (or to a third device, including another device corresponding to the same user or one for another user). As one example, a document that corresponds to the search results in the prior example may be displayed on a tablet computer that is logged into a user account, and the user may highlight text from the document and then swipe a finger across the surface of the tablet's screen. Such an action may indicate that the user would like to transfer a copy of the selected content to another computer, such as a desktop PC on which the user is currently authoring a document (and on which the user may have typed the initial search query). The selected text may, as a direct result of the swiping motion, be passed to a hosted service and then to the user's desktop PC—immediately if the user is logged into the desktop PC at the time, and on a delayed basis if the user is not (for which the transfer may be initiated or the presence of the text may be made known to the user as soon as the user logs in on the desktop PC). The central service may determine that the PC is the desired recipient by recognizing that it previously sent the results to the tablet in response to receiving the query from the desktop PC.

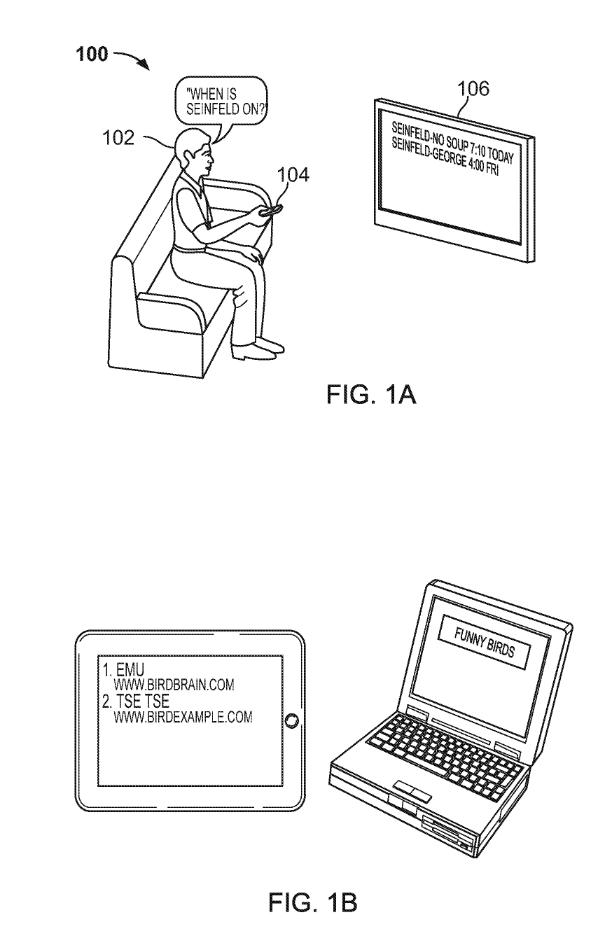

FIGS. 1A and 1B show two examples by which data may be submitted by a first computer and reviewed and handled at a second computer. In FIG. 1A, a system 100 is shown, in which a user 102 of a smartphone 104 is shown sitting on a couch watching a television 106. For example, the user 102 may be sitting down for an evening of watching primetime television but may not know immediately what they want to watch. Alternatively, the user may be watching a show they do not like and may be interested in finding a better show. The user may also be interested in something other than television. For example, the user may be watching the news and may hear reference to a certain geographic area, and may want to perform some quick research to follow up on what they have heard. Other similar interests of the user may be addressed by the system 100.

In this example, the user is shown speaking into the smartphone 104, and asking the query “when is Seinfeld on?” This query, of course, indicates that the user would like to find out when the next episode of the television situation comedy Seinfeld is being shown. The smartphone 104 may be equipped with voice search capabilities, by which certain requests spoken into the smartphone 104 are provided as sound files to a remote server system that may convert the sound files to text and then create search results are responsive to the request.

The television 106 may be a modern television that is provided with a certain level of computing capabilities, and may include wi-fi or other data networking technologies built into the television 106, or provided as an adjunct to the television 106, such as in a cable or satellite box. The smartphone 104 and television 106 may have been previously registered with a search server system and correlated to an account for user 102 (e.g., by the user logging into an account for the user with the devices). In this manner, the search server system may readily determine that the two devices are related to or registered to the user 102, and may perform actions like those discussed here using such knowledge.

When the user 102 speaks the voice command and a sound file is sent to the server system, search results may be sent back to the system 100. In certain implementations, and in a traditional manner, the search results may be displayed on the smart phone 104. However, the smartphone 104 may not be large enough to display a complete electronic program guide grid in the form in which the “Seinfeld” search results may be provided by the system. Also, the smartphone 104 may not be equipped to take appropriate actions using the search results, such as switching automatically to a channel on which an episode of Seinfeld is being played, or programming a personal video recorder to record the current or future episode of Seinfeld that appears in the search results. As a result, in this example, the search results have been provided instead (or in addition) to the television 106, and the user may then further interact with the system 100 to carry out their own particular wishes. As one example, the user may interact further with the smartphone 104, such as using a remote control application for the smartphone 104, so as to cause channels on the television 106, or the cable or set top box, to be changed to the appropriate channel automatically.

The central system may determine to send the results to the television 106 by various mechanisms. For example, the system may identify all devices that are currently logged in or registered for the user, and may then determine which devices may be able to display the relevant results. Where multiple active devices are capable of handling the results, the system may determine which device is most likely to be the target of the user's input. Such a determination may be made, for example, by identifying the active device that is closest to the device that submitted the query, or the device that best matches a type of the results. For example, if the results are determined to be media-related (e.g., they are links to TV episodes and streaming movies), then a television can be preferred over other devices for receiving the results.

FIG. 1B shows an example in which a user employs coordinated implementation of a laptop computer 110 and a tablet display device 112 in a system 108. In this example, the user may be working on a document, such as a term paper, on the laptop computer 110, and may be using the convenience of a physical keyboard on the laptop computer 110 in order to conveniently author and manipulate the data in the paper. The user may also be conducting online research as she works on the paper. It may be inconvenient for the user to have to flip back-and-forth on the laptop computer 110 to see both her paper and their research, and to coordinate mental notes that dictate what words she types in the paper. As a result, in this example, the user is able to enter search queries into a search box on the laptop computer 110 (which has a good physical keyboard for typing such queries), and have the search results appear on the tablet display device 112, in the manners like those discussed above. The search box could be displayed along the periphery of the screen for the laptop computer 110, so that the document that the user is editing may always be displayed in a nearly full screen display on a laptop computer 110.

The user may thus be able to enter the query without moving to the other device, but may have the results appear on the other device, so that they do not cover the work the user was trying to perform on the first device. The user can thus use two screens together in a coordinated manner, including through the cloud, to enter and edit content on one device, and to review content on the other device, where the devices may be connected only through the internet via a hosted service and server system.

In certain implementations, the user may pass some of the data (e.g., from the search results that were automatically passed to the tablet display device 112) from the tablet display device 112 back to the laptop computer 110. For example, the user may drag her finger across a number of words displayed on the tablet display device 112 to highlight the words, and then may perform a flicking gesture across the screen of the tablet display device 112 in order to show an intent that the selected words be shared back over to the laptop computer 110. In such a situation, those words may be provided to a server system to which both devices are registered, and may then be downloaded to the laptop computer 110. The user may then acquire the information from a clipboard functionality that is provided on laptop 110, so that the user may, for example, quickly paste the selected content into the document on which she is working.

In this manner, the system 108 gives a user a convenient way in which to use one device for editing of data, and another device for the review of data, where the first device may be used to push data to the second device, and the second device may be used to push data to the first device, both in very convenient manners.

In certain of these instances, and as described above, some of the communication may take place directly between the two devices. For example, consistent with one implementation discussed above, search results may be provided to the laptop computer 110 from a central server system, and the laptop computer 110 may in turn pass those results to the tablet display device 112. Also, passing of certain information from the tablet display device 112 to the laptop 110 may take place over a short range connection such as over a local WiFi network, and not through a central server system.

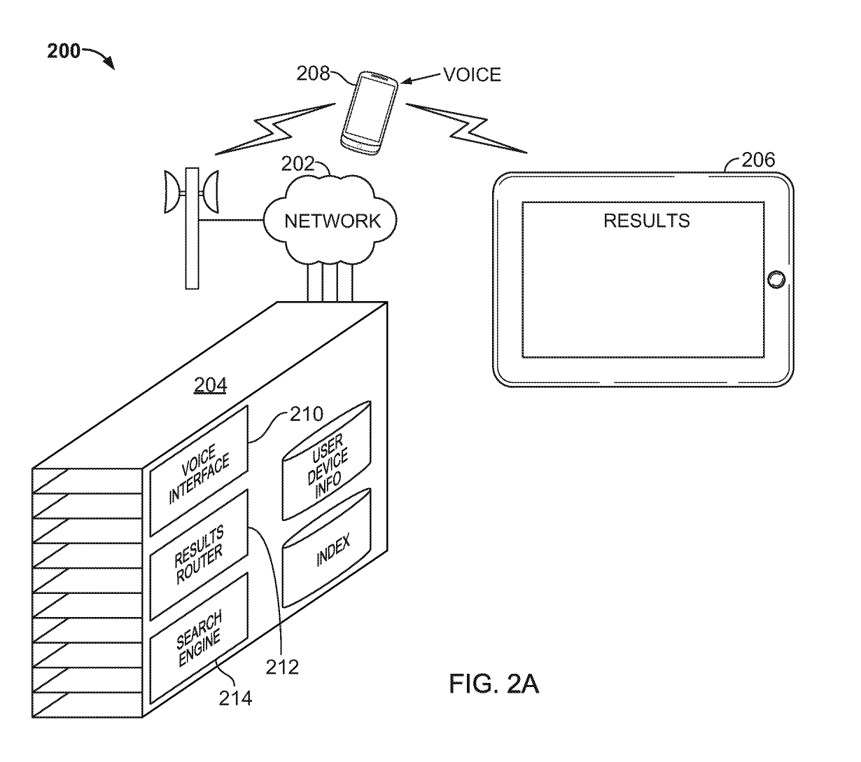

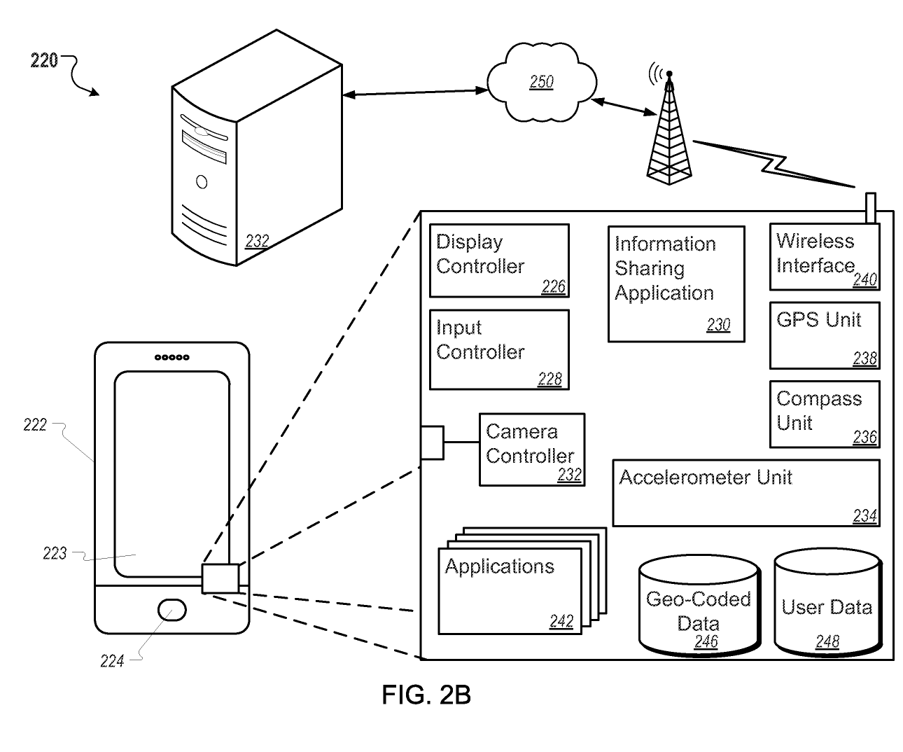

FIG. 2A is a schematic diagram of a system 200 for sharing information between computers. In general, the system 200 is established to allow a user that owns multiple computer devices, to share certain data between devices, including by passing one form of data to the central server system, and having the central server system obtain other data in response to the submissions and provide that other data to a separate target computer that is associated with the users through a user account. The selection of which device to send the data to may be made automatically, such as using data stored in the user's device or by a determination made by the central server system, so that the user need not identify the target of the information when the user asks for the information to be sent.

As shown in the figure, two consumer devices in the form of smartphone 208 and a television 206 are shown and may be owned by a single individual or family. In this example, we will assume that both devices have been logged into a central server system 204 and that communication sessions have been established for both such devices 208, 206. Thus, at the time shown here, submissions could be made separately to the central server system 204 by either of the devices 208, 206, and normal interaction, such as web surfing and other similar interaction that is well known, may be performed in appropriate circumstances with either of the device is.

In this particular example, an arrow is shown entering the smartphone 208 to indicate that a user is speaking voice commands into the smartphone 208. The smartphone 208 may be programmed to recognize certain words that are stated into its microphone, as being words to trigger a search query that involves passing sound data up to the central server system 204 through the network 202, such as the internet. Alternatively, a user may press an on-screen icon on the smartphone 208 in order to change it from a mode for typed input into a mode for spoken input.

In this example, the voice entry is a search query, and the central server system 204 is provided with a number of components to assist in providing search results in response to the search query. For clarity, a certain number of components are shown here, though in actual implementation, a central server system may involve a large number of servers and a large number of other components and services beyond those shown here.

As one example, a voice interface 210 may be provided, and a web server that is part of a central server system 204 may route data received in the form of voice search results to the voice interface 210. The voice interface 210 may initially convert the provided voice input to a textual form and may also perform formatting and conversion on such text. For example, the search system may be implemented so that a user wanting to submit a voice query is required to use a trigger word before the query, either to start the device listening for the query, or to define a context for the query (e.g., “television”). The voice interface 210 may be programmed to extract the trigger word from the text after the speech-to-text conversion occurs because the trigger word is not truly part of the users intended query.

A search engine 204 may receive processed text from the voice interface 210, and may further process the text, such as by adding search terms for synonyms or other information in ways that are readily familiar. The search engine 204 may access information in a search index 218 to provide one or more search results in response to any submitted search query. In certain instances, the context of the search may also be taken into account to limit the types of search results that are provided to the user. For example, voice search may generate particular types of search results more often than other search results, such as local search results that indicate information in a geographical area around the user. Also, certain search terms such as the titles of television shows may indicate to the search engine 214 that the user is presenting a certain type of search, i.e., a media-related search. As a result, the search engine 214 may format the search results in a particular form, such as in the form of an electronic program guide grid for television shows. Such results may also be provided with additional information or meta data, such that a user could select a cell in a program guide so as to provide a message to a personal video recorder to set a recording of that episode.

A results router 212 is responsible for receiving search results 214 from the search engine and providing them to an appropriate target device. In normal operation of a search engine, the target device is the device from which the search query was provided. In this example, though, the target device may be a different device, and the results may be provided to it either directly from the central server system 204, or may be provided to the smartphone 208 and then forwarded to the target device, which in this situation is the television 206. The results router 212 may refer to data in a user device information database 216 to identify the addresses of devices that are associated with an account for the user who is logged in with the particular devices. In this manner, the search system 204 may determine how to properly route results to each of the devices. Thus, for example, if the user provides a television or media-related request by voice, and the system 204 determines from GPS data provided with the request that the user is at home, it may determine to send the results directly to television 206, rather than back to smartphone 208. Also, the system 204 may generate results in a manner that is formatted to best work with television 206, but deliver those results to device 208 in a manner so the device 208 automatically forwards the results for display on television 206. In addition, where a user has multiple televisions, the system 204 may determine which of those televisions is currently logged on and operating, and may determine to send the search results to that particular television.

FIG. 2B is a block diagram of a mobile device 222 and system 220 for sharing information between computers. In general, the system 220 is similar to the system 200 in FIG. 2A, but in this instances additional details about the mobile device 222, which acts as a client here, is provided.

In the example shown, the mobile device 222 is a cellular phone. In other implementations, the mobile device 222 can be a personal digital assistant, a laptop computer, a net book, a camera, a wrist watch, or another type of mobile electronic device. The mobile device 222 includes a camera (not shown) and a display screen 223 for displaying text, images, and graphics to a user, including images captured by the camera. In some implementations, the display screen 223 is a touch screen for receiving user input. For example, a user contacts the display screen 223 using a finger or stylus in order to select items displayed by the display screen 223, enter text, or control functions of the mobile device 222. The mobile device 222 further includes one or more input keys such as a track ball 224 for receiving user input. For example, the track ball 224 can be used to make selections, return to a home screen, or control functions of the mobile device 222. As another example, the one or more input keys includes a click wheel for scrolling through menus and text.

The mobile device 222 includes a number of modules for controlling functions of the mobile device 222, including modules to control the receipt of information and triggering the providing of corresponding information to other devices (which may in turn include the structural components described here for device 222). The modules can be implemented using hardware, software, or a combination of the two. The mobile device 222 includes a display controller 226, which may be responsible for rendering content for presentation on the display screen 203. The display controller 226 may receive graphic-related content from a number of sources and may determine how the content is to be provided to a user. For example, a number of different windows for various applications 242 on the mobile device 222 may need to be displayed, and the display controller 226 may determine which to display, which to hide, and what to display or hide when there is overlap between various graphical objects. The display controller 226 can include various components to provide particular functionality for interacting with displayed components, which may be shared across multiple applications, and may be supplied, for example, by an operating system of the mobile device 222.

An input controller 228 may be responsible for translating commands provided by a user of mobile device 222. For example, such commands may come from a keyboard, from touch screen functionality of the display screen 203, from trackball 224, or from other such sources, including dedicated buttons or soft buttons (e.g., buttons whose functions may change over time, and whose functions may be displayed on areas of the display screen 203 that are adjacent to the particular buttons). The input controller 228 may determine, for example, in what area of the display commands are being received, and thus in what application being shown on the display the commands are intended for. In addition, it may interpret input motions on the touch screen 203 into a common format and pass those interpreted motions (e.g., short press, long press, flicks, and straight-line drags) to the appropriate application. The input controller 228 may also report such inputs to an event manager (not shown) that in turn reports them to the appropriate modules or applications. For example, a user viewing an options menu displayed on the display screen 203 selects one of the options using one of the track ball 224 or touch screen functionality of the mobile device 222. The input controller 228 receives the input and causes the mobile device 222 to perform functions based on the input.

A variety of applications 242 may operate, generally on a common microprocessor, on the mobile device 222. The applications 242 may take a variety of forms, such as mapping applications, e-mail and other messaging applications, image viewing and editing applications, video capture and editing applications, web browser applications, music and video players, and various applications running within a web browser or running extensions of a web browser. In certain instances, one of the applications, an information sharing application 230, may be programmed to communicate information to server system 232 via network 250, along with meta data indicating the user of device 222 wants to have corresponding information provided to a different device that is registered with the system 220 to the user.

A wireless interface 240 manages communication with a wireless network, which may be a data network that also carries voice communications. The wireless interface 240 may operate in a familiar manner, such as according to the examples discussed below, and may provide for communication by the mobile device 222 with messaging services such as text messaging, e-mail, and telephone voice mail messaging. In addition, the wireless interface 240 may support downloads and uploads of content and computer code over a wireless network. The wireless interface 240 may also communicate over short-range networks, such as with other devices in the same room as device 222, such as when results are provided to the device 222 and need to be forwarded automatically to another device in the manners discussed above and below.

A camera controller 232 of the mobile device 222 receives image data from the camera and controls functionality of the camera. For example, the camera controller 232 receives image data for one or more images (e.g. stationary pictures or real-time video images) from the camera and provides the image data to the display controller 226. The display controller 226 then displays the one or more images captured by the camera on the display screen 203. As another example, the camera includes physical zoom functionality. In this example, the camera controller 232 receives input from a user via the input controller 228 and causes the camera to zoom in or out based on the user input. As yet another example, the camera controller 232 controls auto focus functionality of the camera. The captured images may be passed automatically to other computers using the techniques described in this document, and may be passed automatically to other device assigned to a user.

Still referring to FIG. 2, in accordance with some implementations, the information sharing application 230 uses a GPS Unit 238 of the mobile device 222 to determine the location of the mobile device 222. For example, the GPS Unit 238 receives signals from one or more global positioning satellites, and can use the signals to determine the current location of the mobile device 222. In some implementations, rather than the GPS Unit 238, the mobile device 222 includes a module that determines a location of the mobile device 222 using transmission tower triangulation or another method of location identification. In some implementations, the mobile device 222 uses location information that is determined using the GPS Unit 238 to identify geo-coded information that is associated with the location of the mobile device 222. In such implementations, location information obtained or determined by the GPS Unit 238 is provided to the information sharing application 230. In some implementations, the information sharing application 230 uses the location information to identify geo-coded data 246 stored on the mobile device 222.

The geo-coded data 246 includes information associated with particular geographic locations. For example, geo-coded data can include building names, business names and information, historical information, images, video files, and audio files associated with a particular location. As another example, geo-coded data associated with a location of a park may include hours for the park, the name of the park, information on plants located within the park, information on statues located within the park, historical information about the park, and park rules (e.g. “no dogs allowed”). The information sharing application 230 can use the current location of the mobile device 222 to identify information associated with geographic locations that are in close proximity to the location of the mobile device 222. In some implementations, the geo-coded data 246 is stored on a memory of the mobile device 222, such as a hard drive, flash drive, or SD card. In some implementations, the mobile device 222 may contain no pre-stored geo-coded data. In some implementations, none of the geo-coded data 246 stored on the mobile device 222 is associated with locations within relative proximity to the current location of the mobile device 222. The geographical information can be used in various ways, such as passing the data to the central server system 232, so that the central server system may identify a closest logged-in device to the mobile device 222, as that device may be most likely the one to which the system 220 is to send content submitted by the device 220, or a result of the content submitted by the device.

The device 222 utilizes a compass unit 236, or magnetometer, in some examples, e.g., to determine a current viewing direction of a camera on the device 222, within the horizontal plane, of the camera. In other words, the compass unit 236 determines a direction in which a user of the mobile device 222 is looking with the mobile device 220. Viewing direction information provided by the compass unit 236 can be used to determine where information is to be shared with other devices, such as by a system determining to share information with a device in the direction of the user where the user is pointing his or her mobile device 222. In some implementations, the mobile device 222 further includes an accelerometer unit 234 which may be further used to identify a user's location, movement, or other such factors.

Still referring to FIG. 2, in accordance with some implementations, the mobile device 222 includes user data 248. The user data 248 can include user preferences or other information associated with a user of the mobile device 222. For example, the user data 248 can include a list of contacts and a list of ID's for other devices registered to a user. Such information can be used to ensure that information is passed from one person to another.

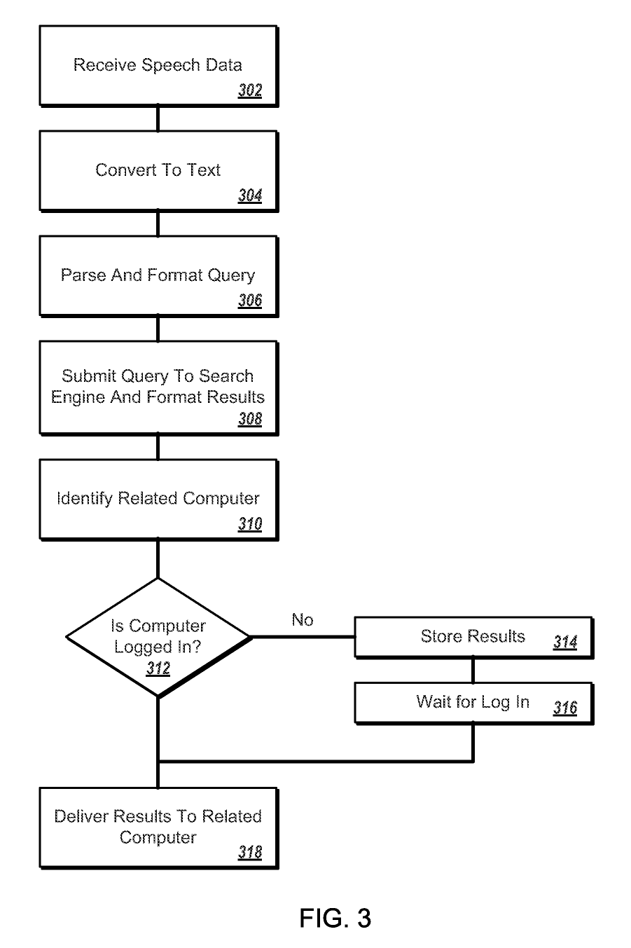

FIG. 3 is a flow chart that shows a process for receiving a request from a first computer and supplying information that is responsive to the request to a second computer. In general, the process involves handling requests from one computing device, generating information responsive to those requests, and providing that generated information to a second computer device that is related to the first computer device via a particular user who has been assigned to both devices.

The process begins at box 302, where speech data is received by the process. For example, a search engine that is available to the public may receive various search queries that users of mobile telephones provide in spoken form. The system may recognize such submissions as being spoken queries in appropriate circumstances and may route them for proper processing. The speech data may in one example be sent with information identifying the device on which the data was received and a location of the device, in familiar manners. Such information may subsequently be used to identify an account for a user of the device, and to determine other devices that are registered to the user in the geographic location of the submitting device.

Thus, at box 304, the speech is converted to text form. Such conversion may occur by normal mechanisms, though particular techniques may be used to improve the accuracy of the conversion without requiring users of the system to train the system for their particular voices. For example, a field in which the cursor for the user was placed when they entered the query may include a label that describes the sort of information that is provided in the field, and such label information may be provided to a search engine so as to improve the results of the conversion. As one example, if a user is entering text into a field of a television-related widget or gadget, the term “television” may be passed to the search engine, and as a result, a speech model may be selected or modified so as to address television-related terms better, such as by elevating the importance of television titles and television character names in a speech model.

At box 306, the query is parsed and formatted. For example, certain control terms may be removed from the query (e.g., terms that precede the main body of the query and are determined not to be what the user is searching for, but are instead intended to control how the query is carried out), synonyms may be added to the query, and other changes may be made to the query to make a better candidate as a search query.

At box 308, the query is submitted to a search engine and results are received back from the search engine and formatted in an appropriate manner. For example, if the search results are results for various times that a television show is to be played, the results may be formatted into an HTML or similar mark-up document that provides an interactive electronic program guide showing the search results in a guide grid. A user displayed the guide may then navigate up and down through channels in the guide and back and forth during times in the guide in order to see other shows being broadcast around the same time, and on different channels, as the identified television program search result.

At box 310, the process identifies a related computer, meaning a computer that is related to the computer that submitted the query. Such a determination may be made, for example, by consulting profile information about a user who submitted the query, to identify all of the computing devices that the user has currently or previously registered with the system, or that are currently logged into the system. Thus, at box 312, the process determines whether a particular one of the computers that are associated with the user are currently logged in. If no such computer is currently logged in or no such computer that is appropriate to receive the content (e.g., because it is a type of computer that can display the content or is a computer geographically near the device that submitted the query), the process may store the results 314 that were to be sent to the other computer. Thus, for example, a user may make search queries while they are not able to view results at home, but such results may be presented to them at home as soon as they log back into their home system. (Box 316). Alternatively, when the user logs in at another device, the system may notify them of pending deliveries from the previously-submitted queries, and they may be allowed to obtain delivery of the information from the queries when they would like.

At box 318, results are delivered to the related computer that was selected in box 310. Such delivery may occur in a variety of forms, including by simply providing a common search results list or grouping to such related computer. The information may ordinarily be delivered via HTML or similar mark-up document that may also call JavaScript or similar executable computer code.

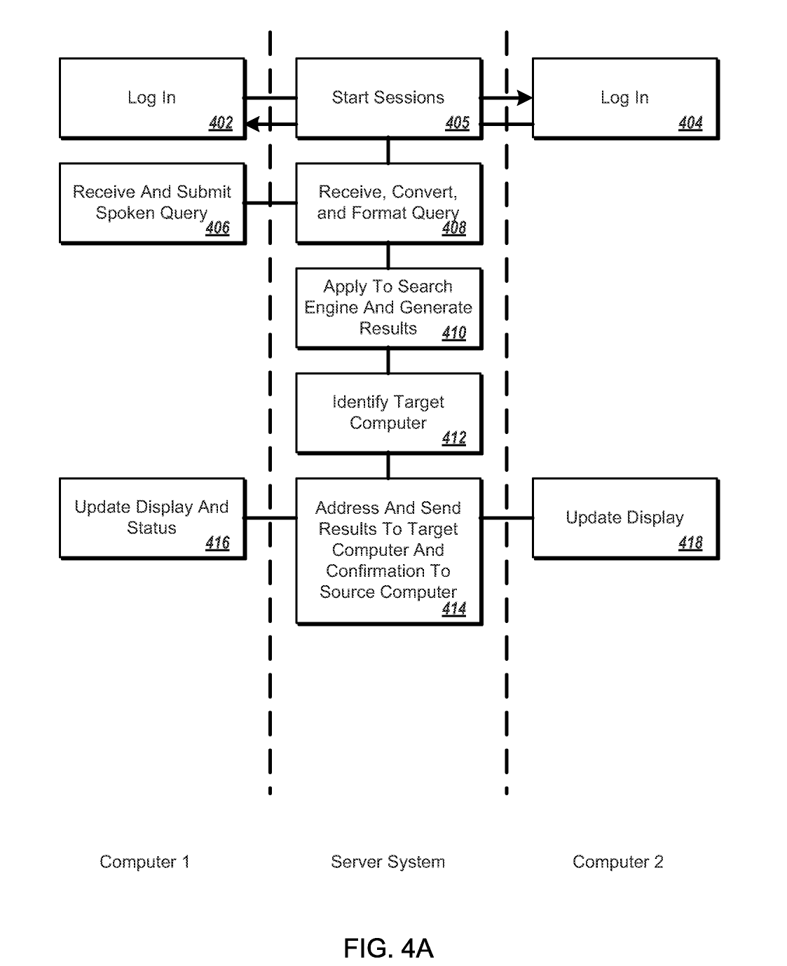

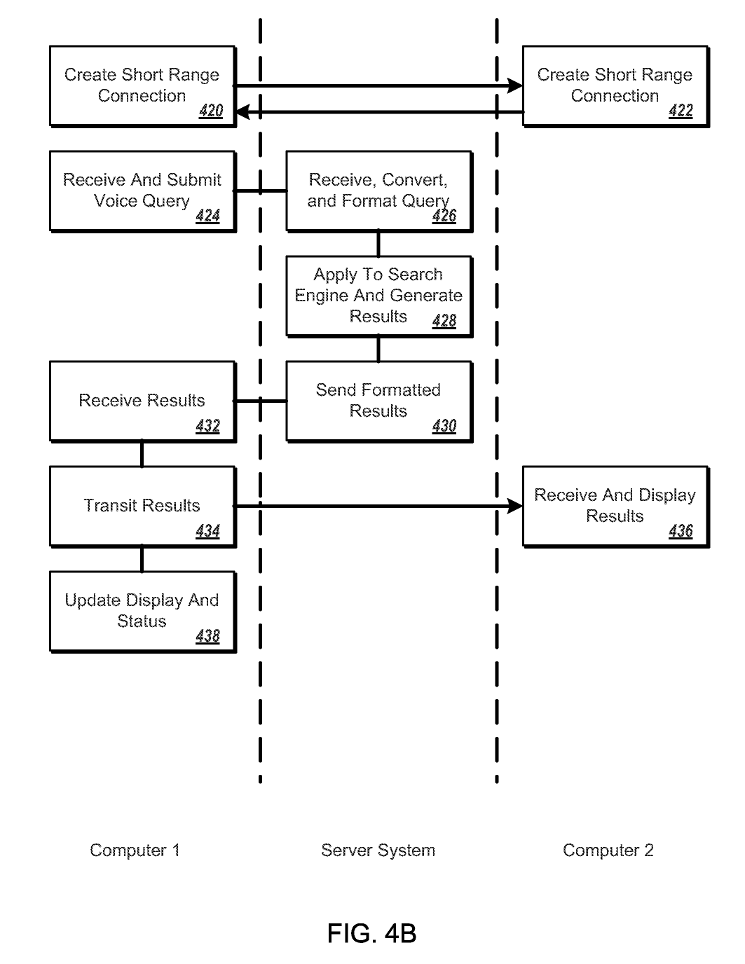

FIGS. 4A and 4B are swim lane diagrams for coordinating information submission and information provision between various computers and a central server system. In general, these figures show processes similar to those shown in FIG. 3, but with particular emphasis showing examples by which certain operations may be performed by particular components in a system.

Referring now to FIG. 4A, the process begins at boxes 402, 404, and 405, where two different computers log in to a central server system and the server system starts sessions for those computers. Although shown as simultaneous processes for clarity here, the two systems may typically log in to a central server system at different times. However, sessions may be kept open for those computers so that communication may continue in an typical manner with the computers. For example, one evening a user may log into a service from a set-top box or hardware integrated into a television, while watching prime time sports. The user may use such a media-watching device to search for information, including web and media-related information, and to have media programs streamed to his or her television. The next morning, the user may log into the same account on his or her desktop computer at work, and may have previously logged into the account on his or her smartphone. By such logging in, each of the devices may be related or correlated to the account, and by extension, to each other.

At box 406, the first computer receives a query in a spoken manner from its user and submits that query to the server system. Such submission may involve packaging the spoken text into a sound file and submitting the sound file to the server system. The submission may occur by the user pressing a microphone button on a smart phone and turning on a recording capability for the smart phone that then automatically passes to the server system whatever was recorded by the user.

At box 408, the server system receives, converts, and formats the query. The converting involves converting from a sound format to a textual speech format using various speech-to-text techniques. The formatting may involve preparing the query in a manner that maximizes the chances of obtaining relevant results to the query, where such formatting may be needed to address an application programming interface (API) for the particular search engine. At box 410, the appropriate formatted query is applied to a search engine to generate search results, and the search results are returned back from the search engine.

At box 412, a target computer for the search query is identified, and may be any of a number of computers that have been associated with an account for which the computing device that has submitted the query was associated. If there are multiple such computers available, various rules may be used to select the most appropriate device to receive the information, such as by identifying the geographic locations of the computer from which the query was received and the geographic locations of the other devices, and sending the results to the device that is closest to the originating device. Such associating another device with the results may occur at the time the results are generated or may occur at a later time. For example, the results may be generated and stored, and then the target device can be determined only after a user logs into the account from the determined target computer.

At box 414, the search results are addressed and formatted, and they are sent to the target computer. Such sending of the results has been discussed above and may occur in a variety of manners. At box 418, the target computer, in this example computer 2, updates its display and status to show the search results and then to potentially permit follow-up interaction by a user of the target computer. Simultaneously in this example, a confirmation is sent to the source computer, or in this example computer 1. That computer updates its display and its status, such as by removing indications of the search query that was previously submitted, and switching into a different mode that is relevant to the submission that the user provided. For example, when a user opens a search box on their device and then chooses voice input, the user may search for the title of a television program, and data for generating an electronic program guide may be supplied to the user's television. At the same time, the user's smart phone may be made automatically to convert to a remote control device for navigating the program guide, so that the user may perform follow-up actions on their search results.

Referring now to FIG. 4B, the process is similar to the process in FIG. 4A, but the results are routed through the first computer before ending up at the second computer. Thus, at boxes 420 and 422, a short-range connection is created between the first and second computer. For example, both of the computers may be provided with WiFi technology or BLUETOOTH technology, and may perform a handshake to establish a connection between them. At box 424, the first computer receives a voice query from its user and submits that voice query to a server system. Such submissions have been described above. At box 426, the server system receives, converts, and formats the query. Again, such operations have been described in detail above. At box 428, the server system applies the query to a search engine, which generates results that are passed back to the server system from the search engine. At box 430, the formatted results are sent by the server system to the first computer which then receives those results at box 432.

The first computer then transmits the results at box 434 over the previously-created short range data connection to the second computer. The second computer then receives those results and displays the results. Such a forwarding of the results from the first computer to the second computer may be automatic and transparent to the user so that the user does not even know the results are passing from the first computer to the second computer, but instead simply sees that the results are appearing on the second computer. An information handling application on the first device may be programmed to identify related devices that are known to belong to the same user as the initiating device, so as to cause information to be displayed on those devices rather than on the initiating device.

At box 436, the display and status of the first computer is updated. Thus, for example, it may be determined that the user does not want to have a search box or voice search functionality continue to be displayed to them after they've receive search results. Rather, the display of the first computer and its status may be changed to a different mode that has been determined to be suited for interaction with whatever information has been provided to the second computer.

In this manner, results generated by a hosted server system for user interaction may be directed to a computer other than the computer on which the user interaction occurred. Such re-directed delivery of the results may provide a variety of benefits, such as allowing a user to direct information to a device that is best able to handle, display, or manipulate the results. Also, the user may be able to split duties among multiple devices, so that the user can enter queries on one device and then review results on another device (and then pass portions of the results back to the first device for further manipulation).

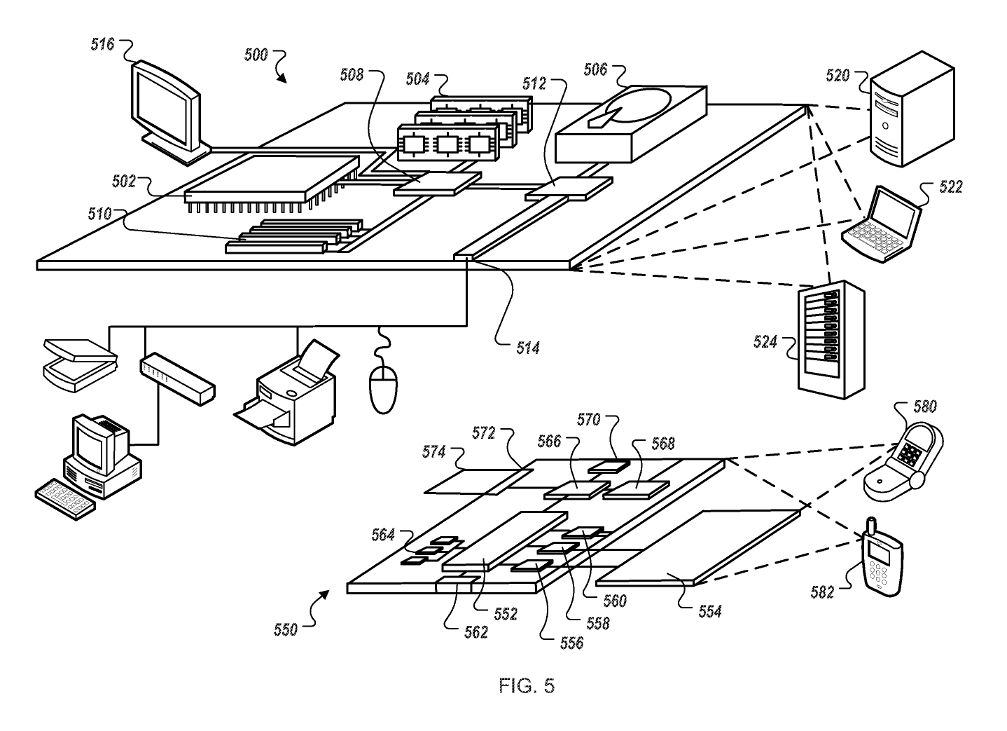

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. Additionally computing device 500 or 550 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made. For example, advantageous results may be achieved if the steps of the disclosed techniques were performed in a different sequence, if components in the disclosed systems were combined in a different manner, or if the components were replaced or supplemented by other components. Accordingly, other embodiments are within the scope of the following claims.

What is claimed is:

1. A computer-implemented method for information sharing between computers, the method comprising:
receiving at a computer system a search request from a first computer;
generating with the computer system one or more search results that are responsive to the first computer;
formatting the results for display on a second computer that is different than the first computer; and
automatically providing the results for display on the second computer.

2. The method of claim 1, further comprising identifying the second computer by identifying a user account to which the first computer corresponds and identifying additional computers that correspond to the user account, the second computer being one of the identified additional computers.

3. The method of claim 1, where providing the results for display on the second computer comprises providing the results to the first computer formatted for automatic forwarding by the first computer to the second computer.

4. The method of claim 1, further comprising receiving a request type for the search request that defines a type of information to be provided in the search results, and automatically selecting the second computer based on the request type.

5. The method of claim 4, further comprising providing the results for display on the second computer only if the request type is a predetermined request type.

6. The method of claim 5, wherein the request type is a television request type, and the second computer is part of a television unit.

7. The method of claim 1, further comprising determining that the second computer is not currently available to display the results, and storing the results at a central server system until the second computer is determined to be available to display the results.

8. The method of claim 1, further comprising receiving from the second computer an indication that a user has selected a portion of the results, and automatically causing the selected portion of the results to be displayed on the first computer in response to receiving the indication, wherein the selected portion of the results is routed through an internet-connected central server system.

9. The method of claim 1, wherein the search request is received as a sound file, and further comprising converting the search request from speech to text.

10. A computer-implemented system for information sharing, the system comprising:
a server interface arranged to receive search queries from a user of a remote source computer;
a search engine to generate results responsive to the received search queries; and
a search result router arranged to cause the results to be automatically provided to a remote target computer that is associated with the user and is different from the remote source computer.

11. The system of claim 10, wherein the server interface is programmed to convert speech queries to text and to submit the text to a search engine.

12. The system of claim 10, wherein the search result router is arranged to identify an address of the remote source computer by identifying computer that are associated with an account with which the source computer is associated.

13. The system of claim 10, wherein the search result router is further programmed to receive from the remote target computer an indication that a user has selected a portion of the results, and automatically causing the selected portion of the results to be displayed on the remote source computer over the internet in response to receiving the indication.

14. A method for controlling a first computing device, comprising:
receiving at a computer system an instruction from a user at a first computing device;
transmitting from the computer system information about the instruction to a second computing device that is different than, but determined to be logged into a same user account as, the first computing device; and
causing the instruction to be executed at the second computing device upon determining that the user has logged into the computer system in using the second computing device.

15. The method of claim 14, wherein the instruction is received as a voice command at the first computing device and translated into a computer-executable instruction for the second computing device.

16. The method of claim 14, where the instruction includes an action and a target for the action.

17. The method of claim 16, wherein the target for the action comprises a software application that is executable on the second computing device, and the action comprises one or more steps to be automatically executed by the application.

18. The method of claim 14, further comprising receiving from the second computing device an indication that a user has manipulated the information and wishes to share the manipulated data with the first computing device, and automatically causing the selected portion of the results to be displayed on the first computing device over the internet in response to receiving the indication.

19. A tangible non-transitory recordable storage media having stored thereon instructions, that when executed, perform actions comprising:
receiving at a first computing device a query from a user of the first computing device;
causing search results for the query to be transmitted to a second computing device that is different than the first computing device but determined to be logged into a same user account as the first computing device; and
receiving and displaying information received in response to a user manipulating the search results at the second computing device.

20. The recordable storage medium of claim 19, wherein the query is received as a voice command at the first computing device and translated into a computer-executable instruction for the second computing device.
